(19) United States
(12) Patent Application Publication
(10) Pub. No.: US 2012/0185238 A1
(43) Pub. Date: Jul. 19, 2012

(54) Auto Generation of Social Media Content from Existing Sources

(76) Inventors: Babar Mahmood Bhatti, Flower Mound, TX (US); Nizam Sayeed, Euless, TX (US); Kenneth W. Loafman, Plano, TX (US); Patrick N. Lawrence, Plano, TX (US)

(21) Appl. No.: 13/007,614

(22) Filed: Jan. 15, 2011

(51) Int. Cl. G06F 17/27

(52) U.S. Cl. 704/9

(57) ABSTRACT

The invention provides for the automatic creation of custom content for social media based on existing text source and a set of preferences and parameters, including automatically preparing the input material from existing text source, automatically generating the social media content of said input material, automatically generating the published content of said social media content, and automatically producing the analysis and report of said published content and its consumption.

for

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This invention relates to the automatic creation of custom content for social media based on existing text source and a set of preferences and parameters.

2. Statement of Problem Addressed by the Invention

It is time consuming and laborious for humans to analyze the exploding body of existing text source to produce customized social media output. Additionally, to optimally perform this task, one may need special training and/or support. The present invention overcomes these disadvantages.

### BRIEF DESCRIPTION OF THE DRAWINGS

FIG. 1 supports the description of the automatic creation of custom content for social media based on existing text source and a set of preferences and parameters.

### EXEMPLARY EMBODIMENT OF A BEST MODE

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in .sctn.112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise. Further, although the following discussion is directed at internet data searching, it is appreciated that the teachings of the exemplary embodiment are equally applicable to databases and other data collections in general.

### DESCRIPTION OF THE DRAWINGS

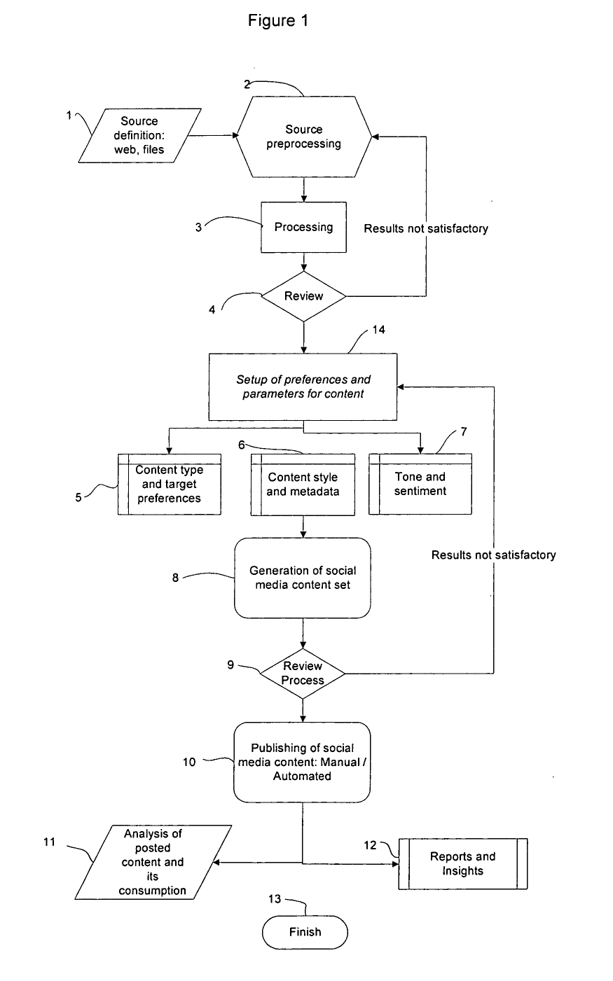

With reference to FIG. 1, the invention comprises the means by which custom content for social media can be created automatically based on existing text source and a set of preferences and parameters.

Reference numerals 1, 2, 3, and 4 comprise the first part of the invention.

Reference numeral 1 is the Source Definition, the definition of the source that can be input into the system. The Source Definition includes

a. Any electronic files or network connected resource from which text can be parsed and processed.

b. Pre-existing electronic text source—files (with extension such as .txt, .doc, .pdf etc) on a hard disk on local or remotely connected resource such as a blog post. For web pages or blogs or other Internet-based content, a full URL is provided to the system so that the system can crawl and browse the contents of the web page.

c. text captured or retrieved from a multimedia object audio, videos—either transcription based, caption based, human rendered in manual form or machine automated.

In addition, the Source Definition handles cases of multiple sources by tagging each source so that analysis can be performed separately and then combined.

Reference numeral 2 is the Source Pre-processing, which acts to

a. Determine fit. Analysis of the source to determine if this is a good fit for generating social media content. Example of a good source is the attached paper “title”. Example of a source which is not a good fit is an article of length less than 10 lines or one which has extensive references associated with it.

b. Separate main content vs. secondary (in reaction to) content. For a social media content where conversations exist (comments to a blog post, for example) the system will capture the conversations and categorize them separately from the main content.

c. Verify language and ability to perform natural language processing.

In addition, the Source Pre-processing will remove non-useful elements, including but not restricted to hypertext, symbols, marks, html, and code, or in other words any non-natural language pieces.

Reference numeral 3 is the Processing, which extracts text of interest, analyzes it and presents the results of the automated processing with a summary of results that include, but are not limited to total words, top keywords used, links or tags, sentiments, opinions, and similar types of results.

Reference numeral 4 is the Review, which is the decision and action point. Based on the processing results, the system decides whether to go ahead with social media content generation on this source text.

a. Option 1: Human review and decision.

b. Option 2: Automated approval process based on rules that match results with a criteria set.

Reference numeral 14 is the Setup of preferences and parameters for content. Now that the input text is ready, the next step is to setup parameters which will govern generation of social media content—such as whether it is micro-content or general notes, and whether the purpose is to find text relevant to a given topic or key word or the purpose is to extract a certain number of useful content pieces.

Reference numeral 5 is the Content type and target preference items that include, but are not limited to:

a. Define target content scope: length of generated content based on character or word count (examples: micro-content—140 characters, a blog post of 1000 words, content of other length etc).

b. Number of content items to be generated (example: create 10 twitter posts).

c. Continuation—allow content to be chopped off in the middle of the sentence and indicate continuation with ellipses.

d. Any target links or URI to be included in the content. For example in case of a blog post as source and micro-blog as target, it is customary to include the source URL as a short URL using a preferred/registered URL shortening service.

e. Citations—author, source.

Reference numeral 6 is the Content style and metadata that include, but are not limited to:

a. Tags or keywords. One option is manual input of tags or keywords that are associated with this content. Another option is to allow the system to auto-generate tags based on an algorithm, for instance an algorithm based on word frequency.

b. What author information needs to be included?

c. Writing style—marketing, information, education, or similar.

d. Is the generated content dependent on business rules? One example could be to vary the content and its style based on audience segmentation. For instance, the system will generate the content with a style suited for youth by including popular abbreviations (abt, gr8).

Reference numeral 7 is the Tone and sentiment. Here the system will indicate the tone and sentiment of the content to be generated. There are a number of ways to do this including specifying writing style, positive/negative sentiments, newspaper headings, and similar.

Reference numeral 8 is the Generation of social media content.

a. Allow an optional input of key words for generating content. If there is no query mentioned, then the system will generate content based on the best intent of the text. When keywords are specified then the system will find the best match for these key words within the text and generate content accordingly.

b. These keywords can have optional weight assignment (for example, user can specify that the phrase “customer care” should have high priority for search by assigning it a weight of 2 as compared with other search terms which are assigned a weight of 1).

c. Duplication avoidance—system will avoid duplication or significant overlap with previously generated content.

Reference numerals 9 and 10 is the Publication of social media content.

Reference numeral 9 is the decision block to Provide the option for human review before publication. A human can review and decide if the results are satisfactory to proceed to next step. For fully automated publishing this step will be skipped.

Reference numeral 10 is the Publication of social media. It is comprised of the following:

a. Decide between an auto publishing process that schedules the content to be published at target location in specified time sequence OR a manual publishing process in which editors manually schedule the publishing of the content.

b. Metadata related to the publishing can be reviewed and modified as mentioned above.

c. Triggers: Generate alerts and notifications in synchronization with publishing.

Assumptions:
The target social media accounts are setup correctly.
The social media sites are available for publishing.
In case there is an error with the account or the social site API does not work as expected then a certain number of attempts will be made per business rules.
In case of repeated unsuccessful attempts, the failure will be recorded and alerts will be sent out (as defined in application setup).

Reference numeral 11 is the Analysis of posted content and its consumption. For content generated and posted, gather data (for instance, aggregate reactions and conversations for the content posted) and analyze effectiveness based on a set of performance indicators (such as number of clicks on links, or number of visits to the target url).

Reference number 12 is the Reports and Insights. Present information in descriptive text, numbers, visual illustrations, and/or charts, or other similar means.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

We claim:

1. A method for automatically creating custom content for social media from existing text source and a list of preferences and parameters, the method comprising:
Automatically preparing the input material from existing text source;
Automatically generating the social media content of said input material;
Automatically generating the published content of said social media content;
Automatically producing the analysis and report of said published content and its consumption.
